(19) United States
(12) Patent Application Publication
(10) Pub. No.: US 2026/0285421 A1
(43) Pub. Date: Sep. 24, 2026

(54) REAR AND FRONT TRACTION MODULES FOR ELECTRICALLY OPERATED AGRICULTURAL TRACTION UNIT

(71) Applicant: DEERE & COMPANY, MOLINE, IL (US)

(72) Inventors: Christian von Holst, Hettenleidelheim (DE); Bijay Kumar Patel, Pune (IN); Thomas Schacht, Gundersheim (DE)

(21) Appl. No.: 19/402,276

(22) Filed: Nov. 26, 2025

(30) Foreign Application Priority Data
Mar. 19, 2025 (EP) 25164811.9

(51) Int. Cl. B62D 49/06; B60K 1/02; B62D 63/02

(52) U.S. Cl. CPC B62D 49/0635; B60K 1/02; B62D 63/025

(57) ABSTRACT

The disclosure relates to a rear traction module for an electrically operated agricultural traction unit, comprising a rear module carrier with rear wheels attached thereto which can be set in rotation by an electric rear drive device, a chargeable energy store for supplying electrical energy to the electric rear drive device, a control unit for controlling the electric rear drive device, and a rear coupling device for establishing a releasable electrical, mechanical or fluidic connection to a front traction module having associated front wheels.

### CROSS-REFERENCE TO RELATED APPLICATIONS

This application claims priority to European Patent Application No. 25164811.9, filed Mar. 19, 2025, which is hereby incorporated by reference.

### TECHNICAL FIELD

The present disclosure relates generally to a rear or front traction module for an electrically operated agricultural traction unit.

### BACKGROUND

The increasing degree of electrification also in the agricultural machine sector entails corresponding challenges with regard to the charging management of the electric drive systems which are usually fed with electrical energy from a chargeable energy store. Thus, the charging pauses of such electrical energy stores can cause work interruptions of up to several hours. In order to ensure uninterrupted operation of, for example, a fully electric agricultural traction unit when cultivating a field by means of a soil cultivation implement attached thereto, it is therefore usually necessary to keep a “charged” substitute traction unit available on site. For many agricultural businesses, such a procedure is unattractive for economic reasons. Alternative approaches which are based on substituting only the electrical energy store can also be implemented logistically only with considerable effort on account of the sensitive rechargeable batteries installed therein, especially in harsh ambient conditions.

### SUMMARY

The object of the present disclosure is to specify an electrically operated agricultural traction unit which is improved in terms of its charging management.

This object is achieved by a rear or front traction module for an electrically operated agricultural traction unit having the features of one or more embodiments disclosed herein, and by an agricultural traction unit, including these modules, having the features of one or more embodiments disclosed herein.

The rear traction module according to the disclosure for an electrically operated agricultural traction unit comprises a rear module carrier with rear wheels attached thereto which can be set in rotation by means of an electric rear drive device, a chargeable energy store for supplying the electric rear drive device with electrical energy, a control unit for controlling the electric rear drive device, and a rear coupling device for establishing a releasable electrical, mechanical and/or fluidic (i.e. hydraulic or pneumatic) connection to a front traction module having associated front wheels.

By dividing the agricultural traction unit into an electrically operated rear traction module, on the one hand, and a front traction module attachable thereto, on the other hand, it is possible to remove the rear traction module separately for recharging the electrical energy store and to replace it by a structurally identical rear traction module with (fully) charged electrical energy store. In this respect, substituting the entire agricultural traction unit is not necessary. This possibility is appropriate in the field of fully electric small and very small tractors since here the weight of the individual traction modules is comparatively low with regard to uncomplicated handling in the case of coupling and uncoupling during the substitution process.

In this case, the rear traction module can be equipped with additional or working units which are typical for agricultural traction units or agricultural tractors. These include, for example, a hydraulically actuatable three-point power lift for attaching an accessory or add-on implement, an electrically driven rear power take-off shaft, selective control valves (SCVs) for operating hydraulic work functions which can be connected thereto, pneumatic connections for actuating a pressure brake system of a towed trailer, or else a standardized ISOBUS or AEF interface. The systems needed to provide the required hydraulic or pneumatic pressure may be part of the rear traction module. On the other hand, it is also conceivable to associate the relevant assemblies to the front traction module, and to establish the electrical, hydraulic and pneumatic connections as necessary to the rear traction module via the rear coupling device. The rear traction module which needs to be substituted when there is a need for charging, multiple examples of which need to be kept ready for this purpose, can in this way be significantly simplified structurally, which entails a corresponding cost advantage.

Typically, the rear traction module comprises an operator station, which is open or surrounded by a driver's cab, with various driving operating elements communicating with the control unit, for controlling the agricultural traction unit, for example, the electric rear drive device, a wheel steering system associated with the front traction module, and a service brake system which has wheel brake devices associated with the front and rear wheels. The relevant driving operating elements are designed as a steering handle or steering wheel, driving operating lever and/or driving or brake pedal. In addition, operating elements for controlling work and operating functions of the agricultural traction unit can be provided.

It is also possible for at least one auxiliary wheel to be attached to the rear module carrier, which auxiliary wheel can be adjusted between a raised transport position and an operating position serving for support with respect to the ground. The at least one auxiliary wheel stabilizes the rear module carrier, preferably in the region of its free end, such that coupling and uncoupling from the front traction module and subsequent transport to the location of a charging station are facilitated. In the raised transport position, the at least one auxiliary wheel can be accommodated in a protective manner by a wheel chamber formed on the rear module carrier.

In order to make possible coupling and uncoupling of the rear traction module to and from the front traction module from the ground, the electric rear drive device can be designed so as to be remotely controllable, for which purpose the control unit can be connected via a wireless interface (Wi-Fi, Bluetooth) to a mobile terminal on which a corresponding remote-control app is installed.

In addition, there is the possibility that mechanical guide means are present which simplify correct mutual positioning of the rear and front traction modules during coupling. The guide means can have a guide cone, provided on the rear traction module, for engaging and centring a guide projection arranged on the front traction module.

As a rule, the chargeable energy store comprises an electrical rechargeable battery, for example a lithium-ion rechargeable battery, a lithium iron phosphate rechargeable battery or a solid-state battery, which is common in the vehicle sector and thus correspondingly tried and tested.

Furthermore, a plug connector, which communicates with a charging management system of the electrical energy store, for establishing a releasable charging connection to a charging station can be arranged on the rear module carrier. The charging management system serves inter alia for monitoring the charging process and can have various charging programs which differ in terms of the charging times. The plug connector is, for example, an IEC type 2 one, which allows the use of public charging stations as well.

Furthermore, a front traction module according to the disclosure is provided which is designed for attachment to a rear traction module according to the disclosure of the type described above. The front traction module according to the disclosure comprises a front module carrier with front wheels attached thereto which can be set in rotation by means of an electric front drive device, a chargeable energy store for supplying the electric front drive device with electrical energy, a control unit for controlling the electric front drive device, and a front coupling device for establishing a releasable electrical, mechanical and/or fluidic connection to a rear traction module having electrically drivable rear wheels or to a driving operating module provided for operating the front traction module on its own.

The front traction module is thus (likewise) electrically drivable and for this purpose has its own electrical energy store. In principle, it is conceivable to use the electrical energy store for buffering the electrical energy store contained in the rear traction module (and vice versa). By means of the charging management system, adaptation or equalization of voltage levels that differ from one another as a result of the charging state can be carried out.

For the sake of completeness, it should be noted that the front traction module can also be designed without its own drive means, i.e. “passively”, and serves merely as a carrier for an additional electrical energy store. In such a case, the front wheels serve at most for steering but otherwise run freely.

The combination of front and rear traction modules thus forms an all-wheel-drive agricultural traction unit which may, for example, have the form of an agricultural tractor. For this purpose, the traction drive implemented by means of the electric front and rear drive device can have individual electric wheel motors which are associated with the front and rear wheels and can be controlled by the two control units on a wheel-specific basis.

The front wheels of the front traction module are usually designed as steerable, for which purpose a wheel steering system with electrical or electrohydraulic actuating means can be provided for influencing a wheel steering angle which can be set at the front wheels.

Optionally, the use of the front traction module in conjunction with the driving operating module allows independent operation of the front traction module as a walking tractor, for example for use with an accessory in the form of a front mower bar, a shovel plate, a leaf blower, a snow blower, or the like which can be attached via a front fastening interface. For this purpose, the front traction module is structurally correspondingly balanced along its longitudinal axis with respect to its centre of gravity. The driving operating module can be a manual steering linkage which can be attached to the front coupling device and which, in addition to left and right hand grips, has a multiplicity of operating elements for controlling a traction drive implemented by the electric front drive device, including active steering, wherein the latter is based on an asymmetrical change in the wheel rotational speed ratios at the front wheels up to an inversion of their directions of rotation. This allows steering and turning manoeuvres to be carried out in the smallest possible space.

Furthermore, at least one auxiliary wheel can be attached to the front module carrier, which auxiliary wheel can be adjusted between a raised transport position and an operating position serving for support with respect to the ground. The at least one auxiliary wheel stabilizes the front module carrier, in the region of its free end, such that coupling and uncoupling to and from the rear traction module and subsequent transport to the location of a charging station are facilitated. In the raised transport position, the at least one auxiliary wheel can be accommodated in a protective manner by a wheel chamber formed on the front module carrier.

Here too, the chargeable energy store can comprise an electrical rechargeable battery in the form of a lithium-ion rechargeable battery, a lithium iron phosphate rechargeable battery or a solid-state battery, wherein a plug connector, which communicates with a charging management system of the energy store, can be arranged on the front module carrier for establishing a releasable charging connection to a charging station. In order to avoid unnecessary repetitions, reference is additionally made in this context to the above description of the corresponding components on the rear traction module.

If use of the front traction module in conjunction with the rear traction module is intended to form an agricultural traction unit, then a hydraulically actuatable three-point power lift for attaching an accessory or add-on implement as well as an electrically driven front power take-off shaft may also be present on the front traction module.

Other features and aspects will become apparent by consideration of the detailed description, claims, and accompanying drawings.

### BRIEF DESCRIPTION OF THE DRAWINGS

The rear or front traction module according to the disclosure for an electrically operated agricultural traction unit is explained in detail below with reference to the attached drawings. Components or assemblies with an equivalent or comparable function are designated here by the same reference signs.

FIG. 1 shows a schematically illustrated exemplary embodiment of an agricultural traction unit including a front traction module according to the disclosure and a rear traction module according to the disclosure,

FIG. 2 shows a view of the rear traction module according to the disclosure reproduced in FIG. 1, in an uncoupled state,

FIG. 3 shows a view of the front traction module according to the disclosure reproduced in FIG. 1, in an uncoupled state, and

FIG. 4 shows a view of the front traction module according to the disclosure illustrated in FIG. 3, with a driving operating module attached thereto.

Like reference numerals are used to indicate like elements throughout the several figures.

### DETAILED DESCRIPTION

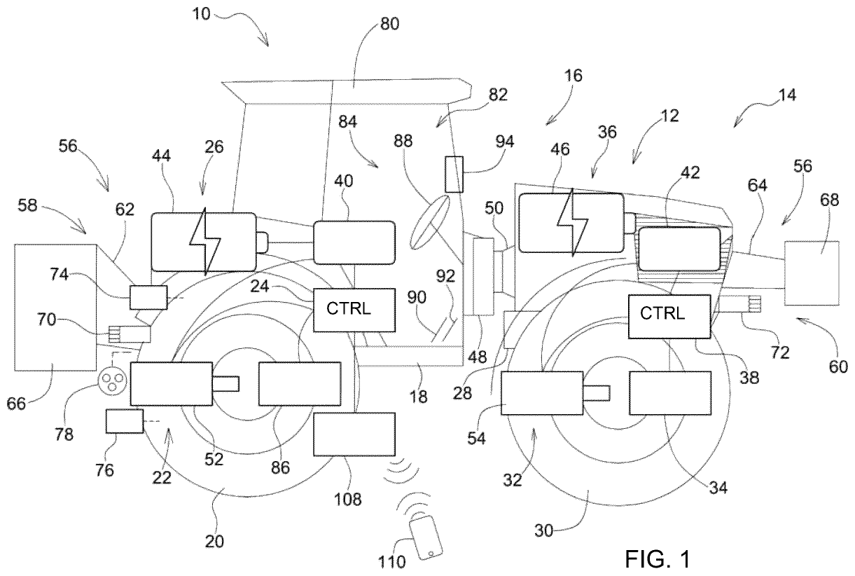

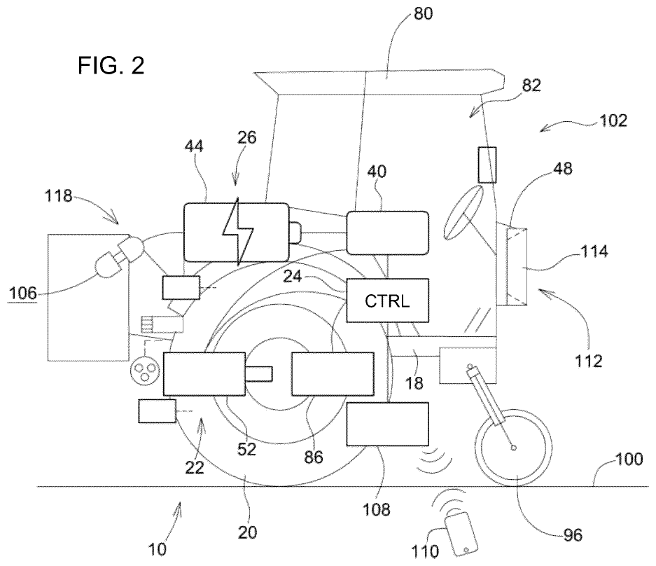

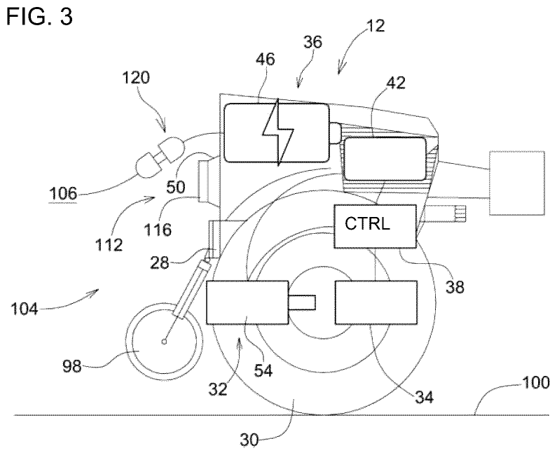

FIG. 1 shows an exemplary embodiment of an agricultural traction unit 14, in the form of an agricultural tractor 16, including of a rear traction module 10 according to the disclosure and a front traction module 12 according to the disclosure. The agricultural traction unit 14 will be explained below with reference to the two individual views of the rear and the front traction module 10, 12 in FIGS. 2 and 3 at the same time.

Accordingly, the rear traction module 10 comprises a rear module carrier 18 with rear wheels 20 attached thereto which can be set in rotation by an electric rear drive device 22. The electric rear drive device 22 which can be controlled by means of a control unit 24 is supplied with electrical energy from a chargeable energy store 26.

In a corresponding manner, the front traction module 12 comprises a front module carrier 28 with front wheels 30, attached thereto, which in turn can be set in rotation by an electric front drive device 32. The front wheels 30 of the front traction module 12 are designed to be steerable, for which purpose a wheel steering system 34 with electrical or electrohydraulic actuating means for influencing a wheel steering angle which can be set at the front wheels 30 is provided. A further chargeable energy store 36 serves to supply electrical energy to the electric front drive device 32 which can be controlled by a further control unit 38. The control units 24, 38 (controllers) may include processor(s) and memory(s).

In other words, the front traction module 12 is likewise electrically drivable and for this purpose has its own electrical energy store 36. The latter is used at the same time for buffering the electrical energy store 26 contained in the rear traction module 10 (and vice versa). By a charging management system 40, 42 associated in each case with the rear or front traction module 10, 12, adaptation or equalization of voltage levels that differ from one another as a result of the charging state is carried out.

The chargeable energy store 26, 36 is in each case an electrical rechargeable battery 44, 46, for example a lithium-ion rechargeable battery, a lithium iron phosphate rechargeable battery or a solid-state battery, which is common in the vehicle sector and thus is correspondingly tried and tested.

In order to establish a releasable electrical, mechanical and/or fluidic (i.e. hydraulic or pneumatic) connection between the rear and front traction module 10, 12, a rear coupling device 48 is attached to the rear module carrier 18 and a front coupling device 50 formed complementarily thereto is attached to the front module carrier 28.

The combination of the rear and front traction modules 10, 12 reproduced in FIG. 1 thus forms an all-wheel-drive agricultural traction unit 14. For this purpose, the traction drive implemented by the electric rear and front drive device 22, 32 has individual electric wheel motors 52, 54 which are associated with the rear and front wheels 20, 30 and which can be controlled on a wheel-specific basis. In this case, the coordination of the traction drive or of the individual wheel motors 52, 54 is affected by the control units 24, 38 which communicate with each other via the rear or front coupling device 48, 50.

Starting from FIGS. 2 and 3, the rear or front traction module 10, 12 is equipped with add-on or work units 56 which are typical of agricultural traction units. These include a hydraulically actuatable three-point power lift 62, 64, which is arranged in the rear or front region 58, 60, for attaching an accessory or add-on implement 66, 68, an electrically driven rear or front power take-off shaft 70, 72, selective control valves (SCVs) 74 for operating hydraulic work functions which can be connected thereto, pneumatic connections 76 for actuating a pressure brake system of a towed trailer, and/or a standardized ISOBUS or AEF interface 78. The systems required for providing the required hydraulic or pneumatic pressure are part of the rear traction module 10. On the other hand, it is also possible to associate the relevant assemblies to the front traction module 12, and to establish the electrical, hydraulic and pneumatic connections as necessary to the rear traction module 10 via the rear or front coupling device 48, 50.

Furthermore, the rear traction module 10 comprises an operator station 82 which is surrounded by a driver's cab 80 and has various driving operating elements 84, which communicate with the associated control unit 24, for controlling the agricultural traction unit 14, inter alia the electric rear and front drive device 22, 32 or the individual electric wheel motors 52, 54, the wheel steering system 34 associated with the front traction module 12, and a service brake system 86 which has wheel brake devices associated with the rear and front wheels 20, 30. The relevant driving operating elements 88 are designed as a steering handle in the form of a steering wheel 88 and/or as a driving or brake pedal 90, 92. In addition, operating elements combined in a user interface 94 are provided for controlling work and operating functions which can be executed, inter alia, by the aforementioned add-on or work units 56 on the rear or front traction module 10, 12.

As can be seen in the respective individual illustrations corresponding to FIGS. 2 and 3, at least one auxiliary wheel 96, 98 is attached to the rear or front module carrier 18, 28, said auxiliary wheel being able to be adjusted between a raised transport position and an operating position serving for support with respect to the ground 100. The at least one auxiliary wheel 96, 98 stabilizes the rear or front module carrier 18, 28 in the region of its free end 102, 104 such that coupling and uncoupling of the rear traction module 10 to and from the front traction module 12 (and vice versa) as well as subsequent transport to the location of a charging station 106 is facilitated. In the raised transport position, the at least one auxiliary wheel 96, 98 is accommodated in a protective manner (not shown) by a wheel chamber formed on the rear or front module carrier 18, 28.

In order to make possible coupling and uncoupling of the rear traction module 10 to and from the front traction module 12 (and vice versa) from the ground, at least the electric rear drive device 22 is designed to be remotely controllable, for which purpose the associated control unit 24 can be connected to a mobile terminal 110 via a wireless interface 108 (Wi-Fi, Bluetooth), on which a corresponding remote-control app is installed.

In addition, mechanical guide means 112 are present in the region of the rear or front coupling device 48, 50 which simplifies correct mutual positioning of the rear and front traction module 10, 12 during coupling. In the present case, the guide means 112 have a guide cone 114 provided on the rear traction module 10 for engaging and centering a guide projection 116 arranged on the front traction module 12.

Arranged on the rear or front module carrier 18, 28 is a plug connector 118, 120, which communicates with the charging management system 40, 42 of the respective electrical energy stores 26, 36, for establishing a releasable charging connection to the charging station 106. The charging management system 40, 42 here serves to monitor the charging process and has various charging programs which differ with respect to the charging times. The plug connector 118, 120 is, for example, an IEC type 2 one, which also allows the use of public charging stations.

By dividing the agricultural traction unit 14 into an electrically operated rear traction module 10, on the one hand, and a front traction module 12 which can be attached thereto, on the other hand, it is possible to remove the rear traction module 10 separately for recharging the electrical energy store 26 and to replace it by a structurally identical rear traction module 10 with the (fully) charged electrical energy store 26. This possibility is appropriate in the field of fully electric small and very small tractors since here the weight of the individual traction modules 10, 12 is comparatively low with regard to uncomplicated handling in the case of coupling and uncoupling during the substitution process.

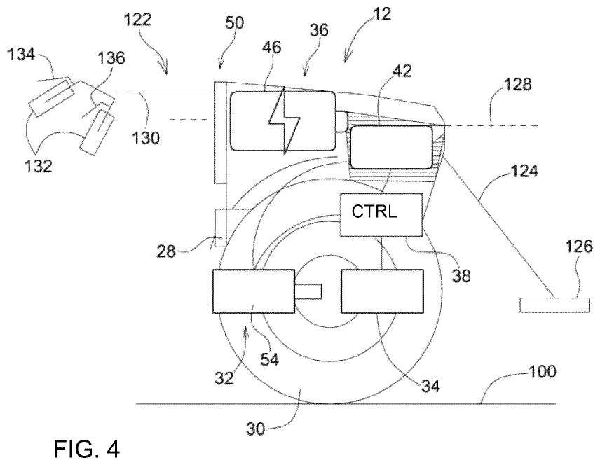

FIG. 4 shows a view of the front traction module 12 with a driving operating module 122 attached thereto and provided for operating the front traction module 12 on its own. The use of the front traction module 12 in conjunction with the driving operating module 122 allows the independent operation of the front traction module 12 as a walking tractor, for example for use with an accessory 126 in the form of a front mower bar, a shovel plate, a leaf blower, a snow blower, or the like which can be attached via a front fastening interface 124. For this purpose, the front traction module 12 is structurally correspondingly balanced along its longitudinal axis 128 with respect to its center of gravity.

The driving operating module 122 is a manual steering linkage 130 which can be attached to the front coupling device 50 and which, in addition to left and right hand grips 132, has a multiplicity of operating elements 134, 136 for controlling the traction drive implemented by the electric front drive device 32, including active steering, wherein the latter is based on an asymmetrical change in the wheel rotational speed ratios at the front wheels 30 up to an inversion of their directions of rotation. This allows steering and turning maneuvers to be carried out in the smallest possible space.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A rear traction module for an electrically operated agricultural traction unit, comprising:
a rear module carrier with rear wheels attached thereto which can be set in rotation by an electric rear drive device,
a chargeable energy store for supplying the electric rear drive device with electrical energy,
a control unit for controlling the electric rear drive device, and
a rear coupling device for establishing a releasable electrical, mechanical or fluidic connection to a front traction module having associated front wheels.

2. The rear traction module of claim 1, wherein at least one auxiliary wheel is attached to the rear module carrier, which auxiliary wheel can be adjusted between a raised transport position and an operating position serving for support with respect to the ground.

3. The rear traction module of claim 1, wherein the electric rear drive device is configured so as to be remotely controllable.

4. The rear traction module of claim 1, wherein mechanical guide means are present for mutual positioning of the rear and front traction modules.

5. The rear traction module of claim 1, wherein the chargeable energy store includes an electrical rechargeable battery.

6. The rear traction module of claim 1, wherein a plug connector, which communicates with a charging management system of the electrical energy store, for establishing a releasable charging connection to a charging station is arranged on the rear module carrier.

7. A front traction module for an electrically operated agricultural traction unit, the front traction module comprising:
a front module carrier with front wheels attached thereto which can be set in rotation by an electric front drive device,
a chargeable energy store for supplying the electric front drive device with electrical energy,
a control unit for controlling the electric front drive device, and
a front coupling device for establishing a releasable electrical, mechanical or fluidic connection to a rear traction module having electrically drivable rear wheels or a driving operating module provided for operating the front traction module,
wherein the rear traction module includes:
a rear module carrier with rear wheels attached thereto which can be set in rotation by an electric rear drive device,
a chargeable energy store for supplying the electric rear drive device with electrical energy,
a second control unit for controlling the electric rear drive device, and
a rear coupling device for establishing another releasable electrical, mechanical or fluidic connection to the front traction module.

8. The front traction module of claim 7, wherein the front wheels of the front traction module are configured as steerable.

9. The front traction module of claim 7, wherein at least one auxiliary wheel is attached to the front module carrier, which auxiliary wheel can be adjusted between a raised transport position and an operating position serving for support with respect to the ground.

10. The front traction module of claim 7, characterized in that the chargeable energy store comprises an electrical rechargeable battery.

11. The front traction module of claim 7, wherein a plug connector, which communicates with a charging management system of the energy store, for establishing a releasable charging connection to a charging station is arranged on the front module carrier.

12. An agricultural traction unit comprising:
a front traction module including:
a front module carrier with front wheels attached thereto which can be set in rotation by an electric front drive device,
a chargeable energy store for supplying the electric front drive device with electrical energy,
a control unit for controlling the electric front drive device, and
a front coupling device for establishing a releasable electrical, mechanical or fluidic connection to a rear traction module having electrically drivable rear wheels or a driving operating module provided for operating the front traction module,
wherein the rear traction module includes:
a rear module carrier with rear wheels attached thereto which can be set in rotation by an electric rear drive device,
a chargeable energy store for supplying the electric rear drive device with electrical energy,
a second control unit for controlling the electric rear drive device, and
a rear coupling device for establishing another releasable electrical, mechanical or fluidic connection to the front traction module.
